(19) United States
(12) Patent Application Publication
(10) Pub. No.: US 2009/0309701 A1
(43) Pub. Date: Dec. 17, 2009

(54) COMPUTER BASED CREDIT CARD

(76) Inventor: Amram Peled, Ramat Gan (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/914,461

(22) PCT Filed: Jun. 3, 2007
(86) PCT No.: PCT/IL07/00676

§ 371 Date: Nov. 15, 2007

Related U.S. Application Data
(60) Provisional application No. 60/804,174, filed on Jun. 8, 2006.

(51) Int. Cl. G06F 7/04

(52) U.S. Cl. 340/5.83

(57) ABSTRACT

A digital computer-based credit card ensuring a high level of security, which prevents unauthorized use, including a magnetic strip, a biometric sensor such as a fingerprint scanner and identifier, displays and indications means, a power source, and a microcomputer, all of which enable application of operation methods including use of data and codes with fixed values and changing values.

### FIELD AND BACKGROUND OF THE INVENTION

The present invention relates to the security of credit cards, passports, ID cards and the like, and in particular to a digital computer-based credit card.

Unauthorized use of credit cards through identity theft causes a great deal of damage to credit card holders, businesses which accept and charge credit cards, and credit companies.

Preventing people from the theft of others' identities is of utmost importance, and to this effect many various and diverse means and methods have been developed over the years. Solutions have drawn on the progressing abilities of technology and design, and have included combination of credit cards and other identification cards with technological components of sufficiently miniscule dimensions, including digital calculation hardware loaded with suitable software and sensors for biometric identification, such as fingerprint identification, as well as the more traditional means of verification used in credit cards such as the signature sample and magnetic strip containing personal information.

A bio-identification card with bio-sensor and user authentication method is described in U.S. patent application Ser. No. 10/989,126 (publication number 200601007067) of Safal Max et al.

FIG. 1 of the prior art illustrates in a perspective view one embodiment of the bio-identification card 20. One aspect of that bio-identification card 20 relates to an identification card including a bio-sensor 21, memory (not shown), and a microprocessor (not shown). The bio-sensor 21 is configured to collect a signature biometric characteristic from a verified user. The memory is configured to store the signature biometric characteristic. The microprocessor is coupled to the bio-sensor 21 and the memory. The microprocessor is configured to retrieve the signature biometric characteristic from the memory and to perform a comparison between the signature biometric characteristic and a sample biometric characteristic. The bio-identification card 20 includes a display screen 22 which can display a countdown 24, indicating the remaining length of time for which a displayed password 25 will be valid. Keypad 23 provides a user interface to communicate with the microprocessor.

The prior art does not teach or suggest a security means or a method which provides sufficient security for credit card holders, businesses which charge credit cards, and credit companies, against malicious use at the levels of sophistication applied nowadays.

There is thus a widely recognized need for, and it would be highly advantageous to have means and method that completely or almost completely prevents, or at least poses extreme difficulties in identity theft and performing illegitimate actions with identification cards in general and credit cards in particular.

### SUMMARY OF THE INVENTION

Additional objects and advantages of the invention will be set forth in part in the description which follows and, in part, will be obvious from the description, or may be learned by practice of the invention.

According to the present invention there is provided a digital computer-based card including: (a) a card body having a flat, thin, rectangular form; (b) a fingerprint scanner and identifier preprogrammed with data relating to a fingerprint of a legitimate holder of the digital computer-based card, assembled to the card body; (c) a microcomputer preprogrammed with a personal identification number constituting a fixed personal code of the legitimate holder of the digital computer-based card, and with a pool of random single-use codes organized in a specific order, assembled to the card body; and (d) a power source assembled to the card body.

According to still further features in the described embodiments the digital computer-based card further including: (e) a magnetic strip preprogrammed with data relating to the legitimate holder of the digital computer-based card, assembled to the card body.

According to still further features in the described embodiments the digital computer-based card further including: (f) a first display screen configured to display data which is stored within the microcomputer.

According to still further features in the described embodiments the microcomputer is preprogrammed with digital data representing a visual portrait of the legitimate holder of the digital computer-based card.

According to still further features in the described embodiments the digital computer-based card further including: (g) a second display screen configured to display a visual portrait of the legitimate holder of the digital computer-based card.

According to still further features in the described embodiments the microcomputer is preprogrammed with a credit card number.

According to still further features in the described embodiments the credit card number has sixteen digits.

According to still further features in the described embodiments the digital computer-based card including no printed card number, and no permanent credit card number display.

According to still further features in the described embodiments the fingerprint scanner and identifier serves also as an activation switch.

According to still further features in the described embodiments the fingerprint scanner and identifier is coupled to compare the data relating to a fingerprint of the legitimate holder of the digital computer-based card to data relating to a fingerprint scanned by the fingerprint scanner and identifier so as to identify if both of the fingerprints belong to a same person, with a predetermined probability.

According to still further features in the described embodiments wherein the microcomputer is so configured that entering the personal identification number into the microcomputer causes the microcomputer to replace the single-use code with a new single-use code, to display the new single-use code, and to transfer a copy of the new single-use code to the magnetic strip.

According to still further features in the described embodiments the digital computer-based card of claim 1, further including: (e) a digital output unit preprogrammed with data relating to a legitimate holder of the digital computer-based card, assembled to the card body.

According to still farther features in the described embodiments the microcomputer is so configured that entering the personal identification number into the microcomputer causes the microcomputer to replace the single-use code with a new single-use code, to display the new single-use code, and to transfer a copy of the new single-use code to the digital output unit.

According to still further features in the described embodiments the second display screen includes an array of at least thirty by forty pixels.

According to still further features in the described embodiments the digital computer-based card further including: (h) a visual logo disposed upon the card body; and (i)

visual personal identification information disposed upon the card body.

According to the present invention there is provided a method of performing a charging transaction, including the steps of: (a) providing a digital computer-based credit card including: (i) a card body having a flat, thin, rectangular form; (ii) a fingerprint scanner and identifier preprogrammed with data relating to a fingerprint of a legitimate holder of the digital computer-based card, assembled to the card body, wherein the fingerprint scanner and identifier is coupled to compare the data relating to a fingerprint of the legitimate holder of the digital computer-based card to data relating to a fingerprint scanned by the fingerprint scanner and identifier so as to identify if both of the fingerprints belong to a same person, with a predetermined probability, and wherein the fingerprint scanner and identifier serves also as an activation switch; (iii) a magnetic strip preprogrammed with data relating to the legitimate holder of the digital computer-based card, assembled to the card body; (iv) a microcomputer preprogrammed with a personal identification number constituting a fixed personal code of the legitimate holder of the digital computer-based card, with a pool of random single-use codes organized in a specific order, and with a credit card number, assembled to the card body, wherein the microcomputer is so configured that entering the personal identification number into the microcomputer causes the microcomputer to replace the single-use code with a new single-use code, to display the new single-use code, and to transfer a copy of the new single-use code to the magnetic strip; and (v) a power source assembled to the card body; (b) activating the digital computer-based credit card by pressing a finger of the legitimate holder of the digital computer-based card to the fingerprint scanner and identifier; (c) entering the fixed personal code into the microcomputer by using keys of the microcomputer; (d) handing the digital computer-based credit card to a person who is intending for performing the charging transaction; (e) running the digital computer-based credit card through a card reader, transmitting the credit card number, and a valid single-use code, to a credit card company; (f) matching the transmitted credit card number and the valid single-use code to data on the credit company's record; and (g) authorizing the charging transaction if result of the matching is positive.

According to still further features in the described embodiments the digital computer-based credit card further includes: (vi) a first display screen configured to display data which is stored within the microcomputer.

According to still further features in the described embodiments the method further including the step of: (h) after activating the digital computer-based credit card, displaying the credit card number and the single-use code on the first display screen.

According to still further features in the described embodiments the method of claim 19, further including the step of: (i) after entering the fixed personal code into the microcomputer, replacing and displaying the single-use code.

According to still farther features in the described embodiments the digital computer-based credit card further includes: (vii) a second display screen configured to display a visual portrait of the legitimate holder of the digital computer-based card.

### BRIEF DESCRIPTION OF THE DRAWINGS

The invention is herein described, by way of example only, with reference to the accompanying drawings, wherein:

FIG. 1 of the prior art schematically illustrates a perspective view of one embodiment of a bio-identification card;

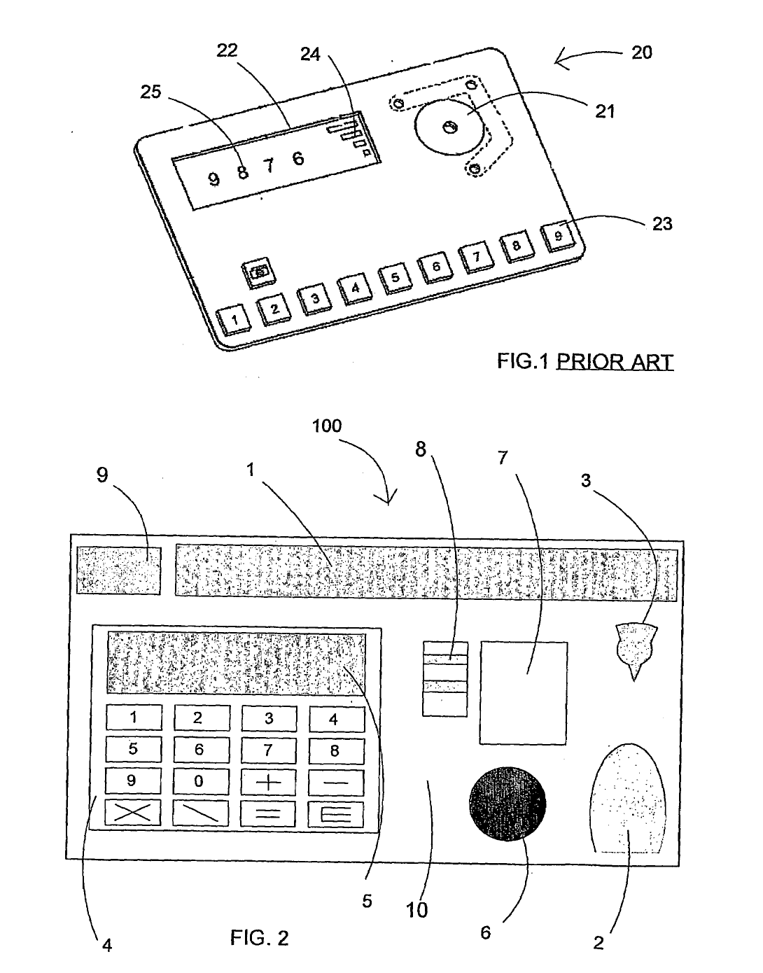

FIG. 2 is a schematic top view illustration a of a digital computer-based credit card, according to an embodiment of the present invention;

FIG. 3 is a flow chart that schematically illustrates one method of operation of the digital computer-based credit card, according to an embodiment of the present invention; and

FIGS. 4a - 4c each separately describe a part of the flow chart of FIG. 3.

### DETAILED DESCRIPTION OF EMBODIMENTS

The present invention is a security card and, in particular a digital computer-based credit card.

The principles and operation of a digital computer-based credit card and a method for its use, according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

Preventing people from the theft of others' identities is of utmost importance, and to this effect many various and diverse means and methods have been developed over the years. However, there are still many cases, in which people manage to overcome the obstacles, steal identities and perform various illegitimate actions such as entering a foreign country using a forged or stolen passport and performance of monetary transactions with stolen or forged credit cards.

According to the present invention, the security of various means is enhanced by combining means and methods in a manner that completely prevents, or at least poses extreme difficulties in identity theft and performing illegitimate actions. The means also includes a magnetic strip which contains the identifying details of the owner of the means, to enable verification, such as name, identification number, date of birth, gender, etc., as well as control means and additional identification means such as biometric identification and in particular fingerprint identification and a single-use code generating microcomputer, which can be stored in a magnetic strip or a digital output unit.

The following list is a legend of the numbering of the application illustrations:
1 magnetic strip
2 fingerprint scanner and identifier
3 logo
4 microcomputer
5 first display screen
6 power source
7 second display screen
8 personal identification information
9 digital output unit
100 card body
100 digital computer-based card
20 prior art bio-identification card
21 prior art bio-sensor
22 prior art display screen
23 prior art keypad
24 prior art displayed countdown
25 prior art displayed password

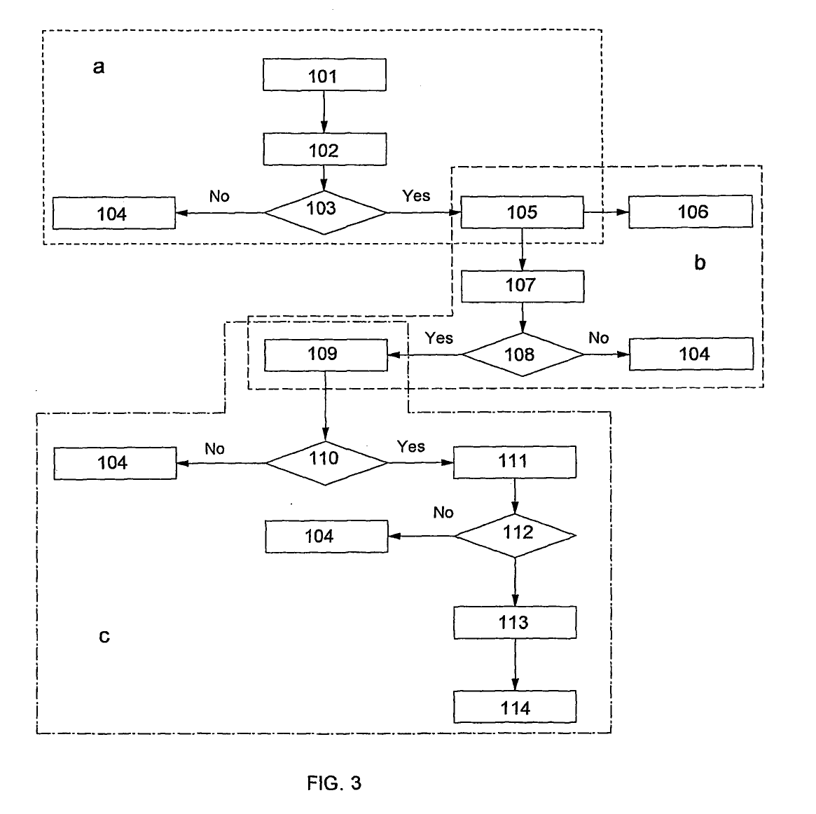

Referring now to the drawings, FIG. 2 is a schematic top view illustration a of a digital computer-based credit card 100, according to a first embodiment of the present invention. The illustration shows magnetic strip 1, which can contain personal details of the legitimate cardholder such as country and city of residence, surname, given name, and additional details such as credit card number, bank branch number and account number, as well as digits, for example three digits, serving as a single-use code which changes with every charge.

According to another embodiment, digital computer-based credit card 100 includes a digital output unit, to which the single-use code information is transmitted as digital data, and which enables reading the data in a designated digital card reading device.

The details of the single-use code are not shown on the card but are registered in the credit card company's database.

Microcomputer 4 of digital computer-based credit card 100 also includes memory, not shown in the illustration, storing a large quantity, in the thousands, of random single-use codes which are unique to every digital computer-based credit card 100 and which are organized in a specific order. The same pool of random codes organized in the same order is also stored in the credit card company's computer memory, for the purpose of comparison and authorization of transactions.

Digital computer-based credit card 100 also includes a biometric sensor, in the first embodiment of the present invention, a fingerprint scanner, and identifier 2, serving also as a means to activate the digital computer-based credit card 100. Digital computer-based credit card 100 is active upon activation for a limited period of time, for example two minutes.

When the digital computer-based credit card 100 is activated, a picture of the legitimate cardholder is displayed on the second display screen 7.

Second display screen 7 has resolution suitable for display of the picture of a person's face which is visibly identifiable, for example a resolution of no less than n×m pixels, or pixel equivalents, with n=30 and m=40.

Digital computer-based credit card 100 also includes a microcomputer 4 which also includes its own first display screen 5. Once digital computer-based credit card 100 is activated, or reactivated, such as by pressing the fingerprint scanner and identifier 2, microcomputer 4 can be used to act as a calculator, even if the digital computer-based credit card 100 is not being used to perform a transaction. To enable use of digital computer-based credit card 100 as a credit card to perform a transaction, the user must enter a Personal Identification Number (PIN), which is a fixed personal code of the legitimate holder of digital computer-based credit card 100. After entering the PIN, first display screen 5 displays a single-use code, which can be a combination of three, four, or more digits which can be used only once for performing a transaction, and which is replaced with a new single-use code immediately after being entered. This single-use code is the last one that was in use. For the first activation of the computer-based credit card 100, prior to having performed any transaction with the card, an arbitrarily predetermined single-use code, such as “000” will be displayed.

Digital computer-based credit card 100 includes a power source 6, which can be an electrical battery, a solar cell with or without a micro-battery, or any other suitable source. Digital computer-based credit card 100 can also include a fixed display of personal identification information 8, such as height and eye color of the legitimate cardholder. Furthermore, digital computer-based credit card 100 can include the logo 3 of the credit card company.

Digital computer-based credit card 100 stores the traditional credit card number in the memory of microcomputer 4, and the number can also be stored on magnetic strip 1 or in the digital output unit 9, as needed. The traditional credit card number is usually 16 digits long, and it can be displayed on the first display screen 5 for selected limited time intervals, thus eliminating the need to have the number regularly displayed on the credit card, as is the common practice in credit cards, increasing the level of security of the card.

The components of digital computer-based credit card 100 are interconnected as necessary with electrical circuits and data pathways, all of which are not shown in the illustration.

All of the components of computer-based credit card 100 comprise an integral mechanical structure, whether they are interconnected directly or integrated, or they are mounted upon or integrated within the card body 10.

The first display screen 5 can also show bank account balance information as well as the single-use code, after being produced at the end of an action cycle.

Normal activation of digital computer-based credit card 10, by the legitimate cardholder, can be according to the following steps:

The legitimate cardholder's, can be according to the following steps:

First step: pressing the digital computer-based credit card's 10 legitimate cardholder's finger to the fingerprint scanner and identifier 2, and activation of digital computer-based credit card 10, which is not yet ready for performing a charging transaction.

Namely, fingerprint scanner and identifier 2 also serves as an activation button which switches digital computer-based credit card 10 to “on” mode, in which it remains for a predetermined fixed time interval, such as two minutes.

Note that the activation of digital computer-based credit card 10 can also be performed by means of pressing another person's finger or even an inanimate object to fingerprint scanner and identifier 2, however without identification of the legitimate cardholder's fingerprint, the sequence of action will not continue.

When the card is activated, information is displayed in rows on first display screen 5, for example as follows:

The first display row shows the legitimate cardholder's line of credit as set by the bank.

The second display row shows the remaining balance available to the legitimate cardholder.

For example, if the line of credit is $20,000, and the legitimate cardholder has so far spent a total of $5,000, the first row will show: “$20,000” and the second row will show “$15,000”, while the third row displays the credit card number, which is traditionally 16 digits long, as well as three additional digits which are the last single-use code displayed on digital computer-based credit card 10.

This display is necessary in case the vendor did not manage to complete all of the necessary actions prior to deactivation of the card. This display enables the vendor to press fingerprint scanner and identifier 2 in order to reactivated the card an continue the charging process. If no charge is made, the legitimate cardholder will be able to enter a command preventing use of the last single-use code displayed for performance of a transaction.

The description of these displays is one example of many possibilities and is not intended to be limiting.

Second step: using the keys of microcomputer 4, the PIN code, which is a fixed personal code of the legitimate holder of digital computer-based credit card 10, is entered. Once the PIN is entered, the single-use code is replaced, and its new three digits are presented at the end of the third display row in place of the previous single-use code. Furthermore, microcomputer 4 transmits the new single-use code to the magnetic strip 1 as analog data, or by another embodiment to the digital output unit 9 as digital data, requiring use of a digital card reader.

The magnetic strip 1 can also contain fixed data such as city, state, the legitimate cardholder's name, the legitimate cardholder's identification number, and the number of the bank branch to which the digital computer-based credit card 10 is billed.

The visual display of the credit card number and the single-use code is necessary for cases of performing transactions such as telephone transactions, internet transactions, or any other transaction in which the data is not read directly off of the card by a device such as a card reader.

Third step: handing the digital computer-based credit card 10 to the vendor or person performing the charge.

Fourth step: running the digital computer-based credit card 10 through a card reader. A number, usually 19 digits long, including the credit card number and the valid single-use code, is transmitted to the credit card company. Matching the transmitted data to the data on the credit company's record is necessary for authorization of the transaction. Many combinations, for example approximately 2,000 digit combinations, serving as single-use codes, are randomly generated and loaded onto the credit card company's computer memory as well as the memory of microcomputer 4, and are organized in the same order on both records.

As noted so far, digital computer-based credit card 10 uses three types of numeric codes, as follows:

a. The credit card number, which is usually a 16 digit long code.

b. Personal identification number (PIN), usually only a few digits long such as 3 or 4.

Both of these codes are embedded in the memory of microcomputer 4 prior to issuing the digital computer-based credit card 10 to its legitimate cardholder, and do not usually change, excepting special cases, for as long as the digital computer-based credit card 10 is in use.

c. The single-use code, which as noted, is composed of three randomly generated digits for single use.

Digital computer-based credit card 100 is not meant to manage the user's bank account, and does not require communication with the bank branch.

In order not to compromise the high level of security it provides, it does not include a communications modem.

The digital computer-based credit card 100 will be designed to enable manual updating of the cards balance, in the case of additional transaction charged without physical use of the digital computer-based credit card 100, such as credit company charges (for example, interest charges). The line of credit will not be able to be manually changed (it can be changed only by the credit company or the bank).

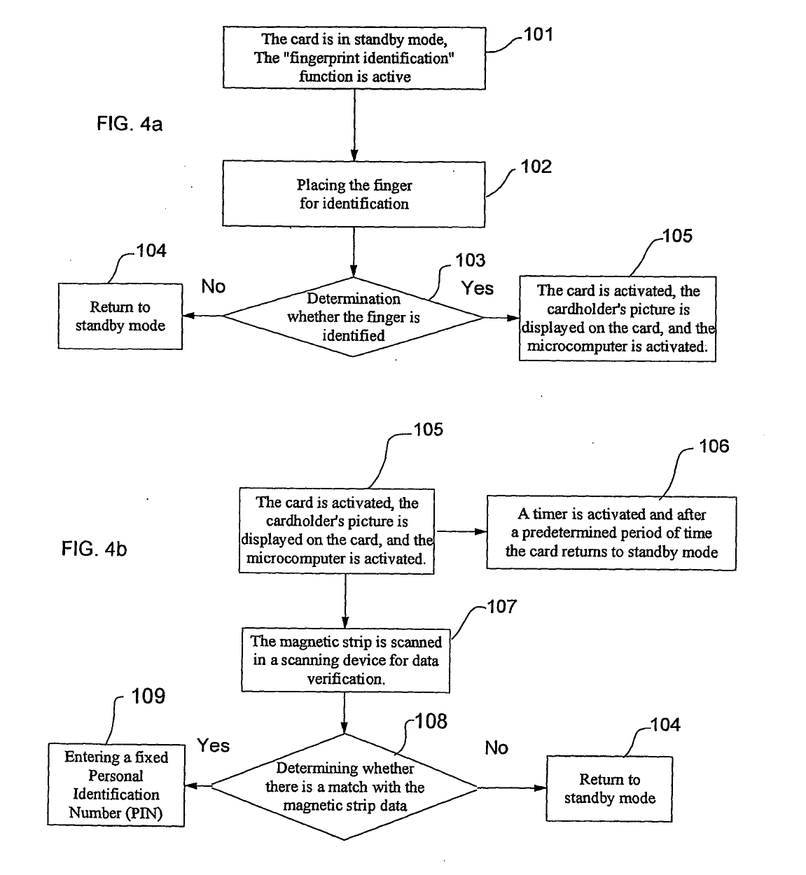

FIG. 3 is a flow chart that schematically illustrates one method of operation of the digital computer-based credit card, according to an embodiment of the present invention.

The shapes in this flow chart are used as follows:
A rectangle indicates a process and/or state.
A diamond indicates a junction of decision.

The illustration shows, in dotted lines, three areas, a, b, and c, each of which includes only a specific part of the method of operation.

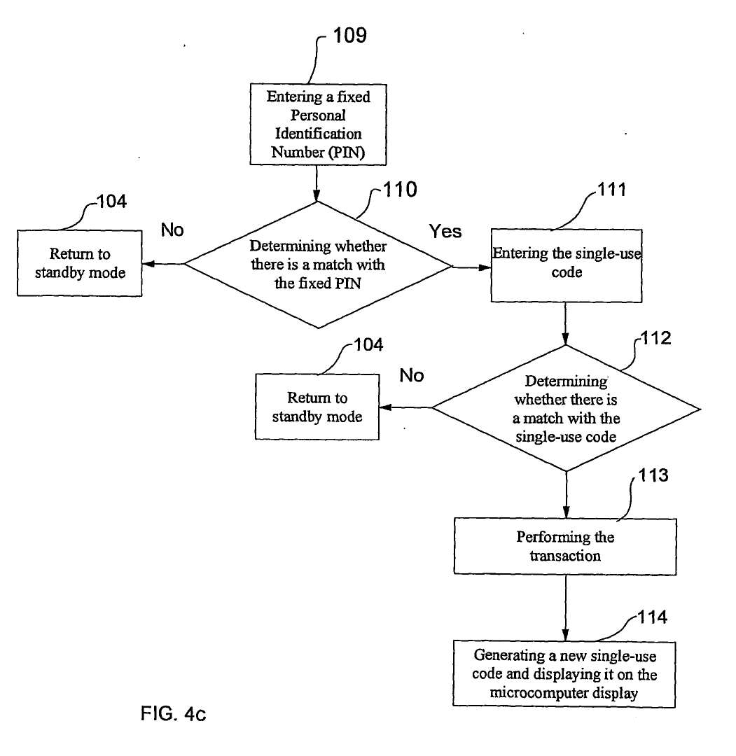

FIGS. 4a -4c each separately describe a part of the flow chart of FIG. 3. While FIGS. 3 only includes the numbering for each rectangle and diamond, these illustrations include a verbal description alongside the numbering, for the reader's convenience.

The following list is a legend of the numbering of the flow chart:
101 The digital computer-based card is in standby mode, the “fingerprint identification” function is active.
102 Placing the finger for identification.
103 Determination whether the finger is identified.
104 Return to standby mode.
105 The digital computer-based card is activated, the legitimate cardholder's picture is displayed on the digital computer-based card, and the microcomputer is activated.
106 A timer is activated and after a predetermined period of time the digital computer-based card returns to standby mode.
107 The magnetic strip is scanned in-a scanning device for data verification.
108 Determining whether there is a match with the magnetic strip data.
109 Entering a fixed Personal Identification Number (PIN).
110 Determining whether there is a match with the fixed PIN.
111 Entering the single-use code.
112 Determining whether there is a match with the single-use code.
113 Performing the transaction.
114 Generating a new single-use code and displaying it on the microcomputer display, the first display screen.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A digital computer-based card comprising:
(a) a card body having a flat, thin, rectangular form;
(b) a fingerprint scanner and identifier preprogrammed with data relating to a fingerprint of a legitimate holder of said digital computer-based card, assembled to said card body;
(c) a microcomputer preprogrammed with a personal identification number constituting a fixed personal code of said legitimate holder of said digital computer-based card, and with a pool of random single-use codes organized in a specific order, assembled to said card body; and
(d) a power source assembled to said card body.

2. The digital computer-based card of claim 1, further comprising:
(e) a magnetic strip preprogrammed with data relating to said legitimate holder of said digital computer-based card, assembled to said card body.

3. The digital computer-based card of claim 2, further comprising:
(f) a first display screen configured to display data which is stored within said microcomputer.

4. The digital computer-based card of claim 3, wherein said microcomputer is preprogrammed with digital data representing a visual portrait of said legitimate holder of said digital computer-based card.

5. The digital computer-based card of claim 4, further comprising:
(g) a second display screen configured to display a visual portrait of said legitimate holder of said digital computer-based card.

6. The digital computer-based card of claim 5, wherein said microcomputer is preprogrammed with a credit card number.

7. The digital computer-based card of claim 6, wherein said credit card number has sixteen digits.

8. The digital computer-based card of claim 6, including no printed card number, and no permanent credit card number display.

9. The digital computer-based card of claim 5, wherein said fingerprint scanner and identifier serves also as an activation switch.

10. The digital computer-based card of claim 5, wherein said fingerprint scanner and identifier is coupled to compare said data relating to a fingerprint of said legitimate holder of said digital computer-based card to data relating to a fingerprint scanned by said fingerprint scanner and identifier so as to identify if both of said fingerprints belong to a same person, with a predetermined probability.

11. The digital computer-based card of claim 5, wherein said microcomputer is coupled to compare said data relating to a fingerprint of said legitimate holder of said digital computer-based card to data relating to a fingerprint scanned by said fingerprint scanner and identifier so as to identify if both of said fingerprints belong to a same person, with a predetermined probability.

12. The digital computer-based card of claim 5, wherein said microcomputer is so configured that entering said personal identification number into said microcomputer causes said microcomputer to replace said single-use code with a new single-use code, to display said new single-use code, and to transfer a copy of said new single-use code to said magnetic strip.

13. The digital computer-based card of claim 1, further comprising:
(e) a digital output unit preprogrammed with data relating to a legitimate holder of said digital computer-based card, assembled to said card body.

14. The digital computer-based card of claim 13, wherein said microcomputer is so configured that entering said personal identification number into said microcomputer causes said microcomputer to replace said single-use code with a new single-use code, to display said new single-use code, and to transfer a copy of said new single-use code to said digital output unit.

15. The digital computer-based card of claim 5, wherein said second display screen includes an array of at least thirty by forty pixels.

16. The digital computer-based card of claim 15, further comprising:
(h) a visual logo disposed upon said card body; and
(i) visual personal identification information disposed upon said card body.

17. A method of performing a charging transaction, comprising the steps of:
(a) providing a digital computer-based credit card including:
(i) a card body having a flat, thin, rectangular form,
(ii) a fingerprint scanner and identifier preprogrammed with data relating to a fingerprint of a legitimate holder of said digital computer-based card, assembled to said card body, wherein said fingerprint scanner and identifier is coupled to compare said data relating to a fingerprint of said legitimate holder of said digital computer-based card to data relating to a fingerprint scanned by said fingerprint scanner and identifier so as to identify if both of said fingerprints belong to a same person, with a predetermined probability, and wherein said fingerprint scanner and identifier serves also as an activation switch;
(iii) a magnetic strip preprogrammed with data relating to said legitimate holder of said digital computer-based card, assembled to said card body;
(iv) a microcomputer preprogrammed with a personal identification number constituting a fixed personal code of said legitimate holder of said digital computer-based card, with a pool of random single-use codes organized in a specific order, and with a credit card number, assembled to said card body, wherein said microcomputer is so configured that entering said personal identification number into said microcomputer causes said microcomputer to replace said single-use code with a new single-use code, to display said new single-use code, and to transfer a copy of said new single-use code to said magnetic strip; and
(v) a power source assembled to said card body;
(b) activating said digital computer-based credit card by pressing a finger of said legitimate holder of said digital computer-based card to said fingerprint scanner and identifier;
(c) entering said fixed personal code into said microcomputer by using keys of said microcomputer;
(d) handing said digital computer-based credit card to a person who is intending for performing the charging transaction;
(e) running said digital computer-based credit card through a card reader, transmitting said credit card number, and a valid single-use code, to a credit card company;
(f) matching said transmitted credit card number and said valid single-use code to data on said credit company's record; and
(g) authorizing said charging transaction if result of said matching is positive.

18. The method of claim 17, wherein said digital computer-based credit card further includes:
(vi) a first display screen configured to display data which is stored within said microcomputer.

19. The method of claim 18, further comprising the step of:
(h) after activating said digital computer-based credit card, displaying said credit card number and said single-use code on said first display screen.

20. The method of claim 19, further comprising the step of:
(i) after entering said fixed personal code into said microcomputer, replacing and displaying said single-use code.

21. The method of claim 17, wherein said digital computer-based credit card further includes:
(vii) a second display screen configured to display a visual portrait of said legitimate holder of said digital computer-based card.
